(19) United States
(12) Patent Application Publication
(10) Pub. No.: US 2024/0154308 A1
(43) Pub. Date: May 9, 2024

(54) PATCH ANTENNA, METHOD, AND NON-TRANSITORY COMPUTER-READABLE MEDIUM

(71) Applicant: NEC Corporation, Minato-ku, Tokyo (JP)

(72) Inventor: Koya Takata, Tokyo (JP)

(73) Assignee: NEC Corporation, Minato-ku, Tokyo (JP)

(21) Appl. No.: 18/278,983

(22) PCT Filed: Jan. 14, 2022
(86) PCT No.: PCT/JP2022/001186

§ 371 Date: Aug. 25, 2023

(30) Foreign Application Priority Data
Mar. 30, 2021 (JP) 2021-057098

(51) Int. Cl. H01Q 9/04; H01Q 13/08

(52) U.S. Cl. CPC H01Q 9/0407; H01Q 13/08

(57) ABSTRACT

An objective of the present disclosure is to provide a patch antenna, a method, and a program that can easily match input impedance of the patch antenna at a predetermined frequency. A patch antenna according to the present disclosure includes: a microstrip line on which a signal is transmitted, provided on liquid crystal and extending in a first direction; a dielectric provided on the microstrip line; a patch antenna element provided on the dielectric, that obtains the signal from the microstrip line through electromagnetic bonding and transmits the signal; and a control unit that changes permittivity of the liquid crystal based on a voltage applied to the liquid crystal to match input impedance of the patch antenna at a predetermined frequency.

### TECHNICAL FIELD

The present disclosure relates to a patch antenna, a method, and a program, and in particular to a patch antenna, a method, and a program that can easily match input impedance of the patch antenna at a predetermined frequency.

### BACKGROUND ART

In general, in order to improve efficiency of transmission and reception of an antenna, it is necessary to match input impedance of when a signal is input from a transmission line to the antenna at a predetermined frequency. A method for matching the input impedance is mainly exemplified by three methods. The first method matches the impedance by changing a shape of an antenna. For example, a dipole antenna has a characteristic that a frequency to match is changed by bending a linear portion of the antenna midway. By leveraging this characteristic, the input impedance is matched at a predetermined frequency by optimizing a position and an angle of bending of the dipole antenna. However, in a case of changing the frequency to match to a predetermined frequency in the first method, it is required to physically change the position of bending and the like of the antenna, leading to a problem of difficulty in facilitating the change of the frequency to match. The second method matches the impedance by changing a feed point of an antenna. However, in the second method as well, in a case of changing the frequency to match to a predetermined frequency, it is required to physically change the feed point of the antenna, leading to a problem of difficulty in facilitating the change of the frequency to match. The third method matches the impedance by using a matching device. Specifically, the matching device is provided between the antenna and a feeding cable, and impedance of the matching device is changed to match the impedance of the antenna. The third method has problems of an increase in size of the vicinity of the antenna by the size of the matching device, and an increase in overall cost by the cost of the matching device. Note that a circuit constituting the matching device may also be referred to as a matching circuit.

Patent Literature 1 discloses in paragraphs [0019] and [0020] the following: a power supply unit is disposed on the same first surface of a matching circuit board as a surface on which an antenna unit is disposed, and the power supply unit is electrically connected to the antenna unit via the transmission line; the transmission line is disposed on the first surface of the matching circuit board; the transmission line extends linearly, for example, and is disposed between the power supply unit and the antenna unit; and one end of the transmission line is electrically connected to the power supply unit, and the other end is electrically connected to the antenna unit. In addition, Patent Literature 1 discloses in paragraphs [0042] and [0043] the following: a permittivity control unit includes, for example, a power supply unit and a control circuit, and a positive electrode thereof is electrically connected to a permittivity variable unit via an application electrode, and applies a voltage to the permittivity variable unit; accordingly, the permittivity control unit carries out variable control of the permittivity of the permittivity variable unit; according to the configuration of the second embodiment, since the permittivity of the permittivity variable unit can be controlled, it is possible to adjust the matching condition of the impedance matching; and it is therefore possible to realize more suitable impedance matching. Patent Literature 1 does not disclose transmitting a high frequency signal from a microstrip line to a patch antenna element through electromagnetic bonding and optimizing a voltage applied to liquid crystal, to match input impedance at a predetermined frequency.

### CITATION LIST

### Patent Literature

Patent Literature 1: Japanese Unexamined Patent Application Publication No. 2020-10125

### SUMMARY OF INVENTION

### Technical Problem

As described above, there has been a problem of difficulty in changing input impedance of an antenna, leading to difficulty in facilitating matching of the input impedance of the antenna at a predetermined frequency. In addition, in the case of using a matching device, there has been problems of an increase in size and an increase in cost by the size and cost of the matching device.

An object of the present disclosure is to provide a patch antenna, a method, and a program for solving any one of the above-described problems.

### Solution to Problem

A patch antenna according to the present disclosure includes: a microstrip line on which a signal is transmitted, provided on liquid crystal and extending in a first direction; a dielectric provided on the microstrip line; a patch antenna element provided on the dielectric, that obtains the signal from the microstrip line through electromagnetic bonding and transmits the signal; and a control unit that changes permittivity of the liquid crystal based on a voltage applied to the liquid crystal to match input impedance of the patch antenna at a predetermined frequency.

A method according to the present disclosure is for controlling input impedance of a patch antenna including: a microstrip line on which a signal is transmitted, provided on liquid crystal and extending in a first direction; a dielectric provided on the microstrip line; and a patch antenna element that obtains the signal from the microstrip line through electromagnetic bonding and transmits the signal, the method comprising: changing permittivity of the liquid crystal based on a voltage applied to the liquid crystal; and matching input impedance of the patch antenna at a predetermined frequency by changing permittivity of the liquid crystal.

A program according to the present disclosure is for controlling input impedance of a patch antenna including: a microstrip line on which a signal is transmitted, provided on liquid crystal and extending in a first direction; a dielectric provided on the microstrip line; and a patch antenna element that obtains the signal from the microstrip line through electromagnetic bonding and transmits the signal, the program causing a computer to carry out: changing permittivity of the liquid crystal based on a voltage applied to the liquid crystal; and matching an input impedance of the patch antenna at a predetermined frequency by changing permittivity of the liquid crystal.

### Advantageous Effects of Invention

The present disclosure can provide a patch antenna, a method, and a program that can easily match input impedance of the patch antenna at a predetermined frequency.

### BRIEF DESCRIPTION OF DRAWINGS

FIG. 1 is a perspective view showing a patch antenna according to a first example embodiment;

FIG. 2 is a schematic view showing an example of a configuration of the patch antenna according to the first example embodiment;

FIG. 3 is a graph showing an example of an operation of the patch antenna according to the first example embodiment;

FIG. 4 is a graph showing an example of an operation of the patch antenna according to the first example embodiment;

FIG. 5 is a schematic view showing an example of a configuration of the patch antenna according to Comparative Example of the first example embodiment;

FIG. 6 is a perspective view showing an example of a transmission line of the patch antenna according to a second example embodiment;

FIG. 7 is a perspective view showing an example of a transmission line of the patch antenna according to the second example embodiment;

FIG. 8 is a perspective view showing the patch antenna according to the second example embodiment;

FIG. 9 is a perspective view showing an example of a transmission line of the patch antenna according to a third example embodiment;

FIG. 10 is a graph showing an example of an operation of the patch antenna according to the third example embodiment; and

FIG. 11 is a graph showing an example of an operation of the patch antenna according to the third example embodiment.

### EXAMPLE EMBODIMENT

Example embodiments according to the present invention will be described hereinafter with reference to the drawings. In addition, in each of the drawings, the same or corresponding element is denoted by the same symbol and repeated explanation is omitted as needed for the sake of clarity of description.

### First Example Embodiment

<Configuration of Antenna>

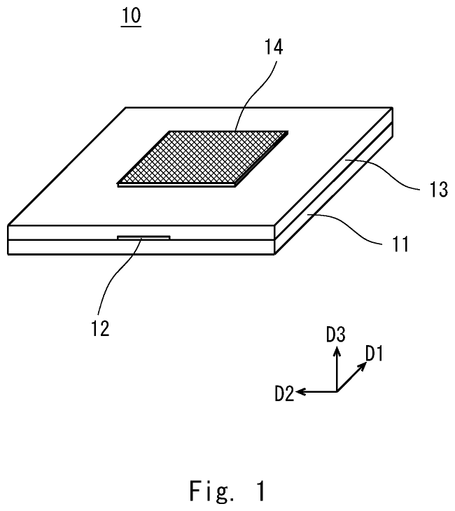

FIG. 1 is a perspective view showing a patch antenna according to the first example embodiment.

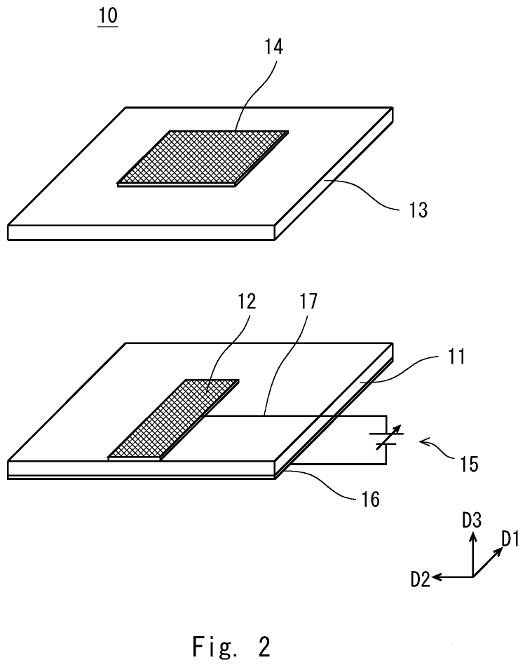

FIG. 2 is a schematic view showing an example of a configuration of the patch antenna according to the first example embodiment.

In FIG. 2, in order to illustrate configuration of the patch antenna 10 according to the first example embodiment in further detail, the dielectric and the liquid crystal are separated. In other words, in reality, the dielectric and the liquid crystal of the patch antenna 10 are in contact with each other as illustrated in FIG. 1.

As illustrated in FIG. 1 and FIG. 2, the patch antenna 10 according to the first example embodiment includes liquid crystal 11, a microstrip line 12, a dielectric 13, a patch antenna element 14, and a control unit 15.

The microstrip line 12 is provided on the liquid crystal 11. The microstrip line 12 extends in a first direction D1, and a signal is transmitted on the microstrip line 12. Since a high-frequency signal is transmitted in the signal, the signal may also be referred to as a high-frequency signal. In addition, the microstrip line may also be simply referred to as a transmission line.

The dielectric 13 is provided on the microstrip line 12.

The patch antenna element 14 is provided on the dielectric 13. The patch antenna element 14 obtains the signal from the microstrip line 12 through electromagnetic bonding, and transmits the obtained signal from the own patch antenna element 14.

The control unit 15 changes permittivity of the liquid crystal 11 based on a voltage applied to the liquid crystal 11. The control unit 15 matches input impedance of the patch antenna 10 at a predetermined frequency by changing permittivity of the liquid crystal 11.

Specifically, the control unit 15 determines that the input impedance is matched when the input impedance of the patch antenna 10 is within the predetermined impedance range at the predetermined frequency. The matching may also be referred to as matching.

A method of applying a voltage to be applied to the liquid crystal 11 is described hereinafter.

The method of applying includes, as shown in FIG. 2, providing a negative electrode 16 provided in contact with a lower face of the liquid crystal 11 and a positive electrode 17 provided to be connected to the microstrip line 12. The control unit 15 uses the positive electrode 17 and the negative electrode 16 to generate the voltage and apply the voltage to the liquid crystal 11. Note that the negative electrode may also be referred to as a ground.

<Operation of Antenna>

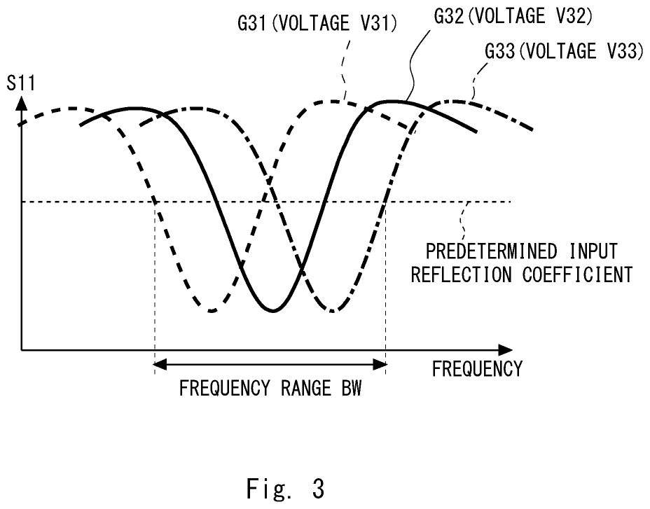

FIG. 3 is a graph showing an example of an operation of the patch antenna according to the first example embodiment.

In FIG. 3, the abscissa represents frequency and the ordinate represents an input reflection coefficient S11.

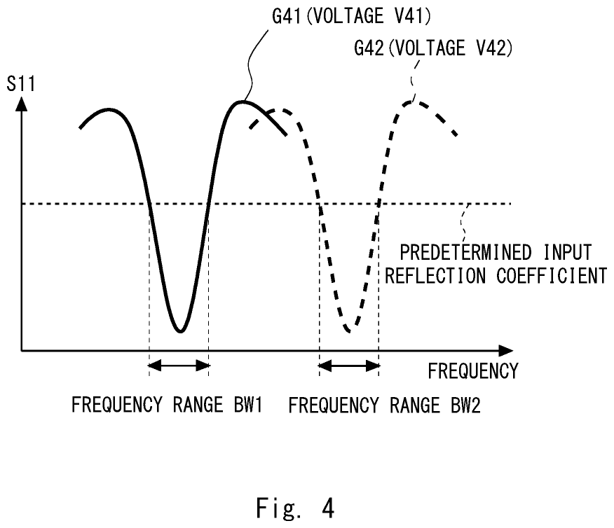

FIG. 4 is a graph showing an example of an operation of the patch antenna according to the first example embodiment.

In FIG. 4, the abscissa represents frequency and the ordinate represents an input reflection coefficient S11.

FIG. 3 and FIG. 4 illustrate a frequency characteristic of the input reflection coefficient S11 of when the voltage applied to the liquid crystal 11 is changed.

In the patch antenna 10, by matching the impedance of the microstrip line 12 with the impedance of the patch antenna element 14, signal reflection from the patch antenna element 14 is reduced, resulting in a reduction in the input reflection coefficient S11. Thus, matching the impedance corresponding to reducing the input reflection coefficient S11. Therefore, matching the impedance is described herein as the input reflection coefficient S11 being no greater than a predetermined reflection coefficient.

As illustrated in FIG. 3, when the voltage applied to the liquid crystal 11 is increased from a voltage V31 to a voltage V33 via a voltage V32, the frequency characteristic of the input reflection coefficient S11 is moved from a graph G31 to a graph G33 via a graph G32. This is because, when the voltage applied to the liquid crystal 11 is changed, the permittivity of the liquid crystal 11 is changed, whereby a wavelength shortening coefficient of when the signal is transmitted on the microstrip line 12 is changed, resulting in a change in a frequency range in which the input reflection coefficient S11 is no greater than the predetermined reflection coefficient.

As described above, the patch antenna 10 according to the first example embodiment can control the frequency, at which the input impedance of the patch antenna 10 is matched, over a frequency range BW by the control unit 15 changing the voltage applied to the liquid crystal 11 (see FIG. 3). For example, when the input reflection coefficient S11 as represented by the graph G31 is desired, the control unit 15 sets the voltage V31 as the voltage applied to the liquid crystal 11. Alternatively, for example, when the input reflection coefficient S11 as represented by the graph G32 is desired, the control unit 15 sets the voltage V32 as the voltage applied to the liquid crystal 11. Yet alternatively, for example, when the input reflection coefficient S11 as represented by the graph G33 is desired, the control unit 15 sets the voltage V33 as the voltage applied to the liquid crystal 11.

As a result, according to the first example embodiment, a broadband antenna covering the frequency range BW can be realized without a matching device. As a result, a patch antenna, a method, and a program that can easily match input impedance of the patch antenna at a predetermined frequency can be provided.

In addition, according to the first example embodiment, when the input reflection coefficient S11 as represented by the graph G41 is desired, in other words when a frequency range in which the input reflection coefficient S11 is no greater than the predetermined input reflection coefficient is a frequency range BW1, as shown in FIG. 4, the control unit 15 sets the voltage V41 as the voltage applied to the liquid crystal 11. Furthermore, when the input reflection coefficient S11 as represented by the graph G42 is desired, in other words when a frequency range in which the input reflection coefficient S11 is no greater than the predetermined input reflection coefficient is a frequency range BW2, the control unit 15 sets the voltage V42 as the voltage applied to the liquid crystal 11.

As a result, according to the first example embodiment, an antenna covering a dual band of the frequency range BW1 or the frequency range BW2 can be realized without a matching device. Note that the single patch antenna 10 does not cover the frequency range BW1 or the frequency range BW2 at the same time.

In addition, according to the first example embodiment, since the shape of the patch antenna 10 is not changed, an impact on the directivity (gain) of the antenna is small.

Furthermore, according to the first example embodiment, since the matching device is not used, the device including the patch antenna 10 can be reduced in size, and the cost can be reduced by omitting the matching device.

<Features>

Features of the patch antenna 10 according to the first example embodiment are described hereinafter.

The patch antenna 10 can match impedance at a desired frequency by providing the liquid crystal 11 below the microstrip line 12 (transmission line) and applying a voltage to the liquid crystal 11 to change the permittivity of the liquid crystal 11.

In addition, the patch antenna 10 transmits a high frequency signal from the microstrip line 12 to the patch antenna element 14 through electromagnetic bonding and optimizes the voltage applied to liquid crystal 11, to match the input impedance at a predetermined frequency.

### COMPARATIVE EXAMPLE

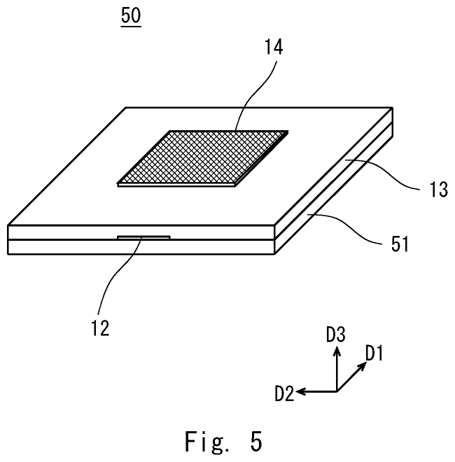

FIG. 5 is a schematic view showing an example of a configuration of the patch antenna according to Comparative Example of the first example embodiment.

As illustrated in FIG. 5, a patch antenna 50 according to Comparative Example is different from the patch antenna 10 according to the first example embodiment in that a dielectric 51 is mounted instead of the liquid crystal 11 below the microstrip line 12.

The patch antenna 50 without the liquid crystal 11 mounted cannot change permittivity of the dielectric 51. The patch antenna 50 cannot change the permittivity and thus cannot change a frequency characteristic of impedance, whereby matching of input impedance at a predetermined frequency is difficult. It is also difficult to broaden the band. As a result, it is difficult to provide a patch antenna that can easily match input impedance of the patch antenna at a predetermined frequency.

### Second Example Embodiment

<Configuration of Antenna>

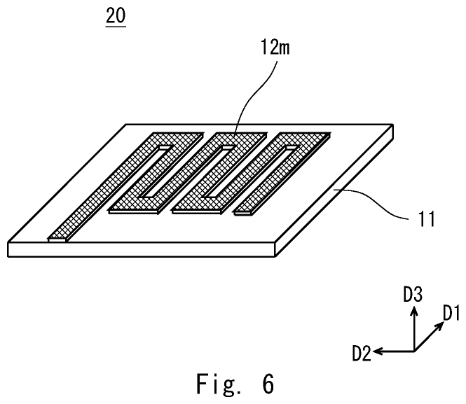

FIG. 6 is a perspective view showing an example of a transmission line of the patch antenna according to the second example embodiment.

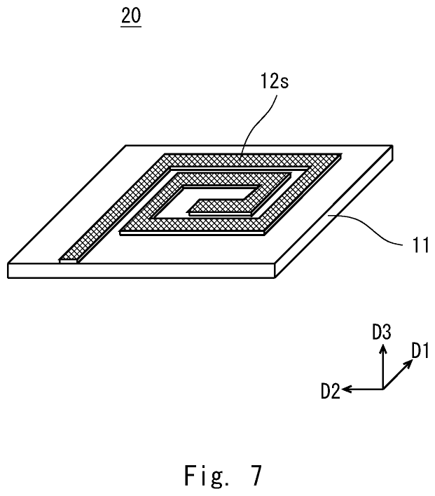

FIG. 7 is a perspective view showing an example of a transmission line of the patch antenna according to the second example embodiment.

In FIG. 6 and FIG. 7, the dielectric 13 and the patch antenna element 14 are omitted for convenience.

As illustrated in FIG. 6, a patch antenna 20 according to the second example embodiment is different from the patch antenna 10 according to the first example embodiment in that a meandering transmission line 12m is used instead of the microstrip line 12.

In addition, as illustrated in FIG. 7, the patch antenna 20 according to the second example embodiment is different from the patch antenna 10 according to the first example embodiment in that a spiral transmission line 12s is used instead of the microstrip line 12.

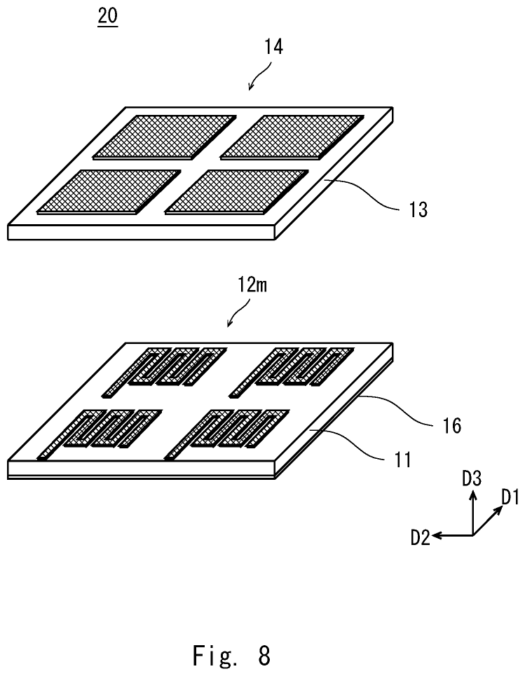

FIG. 8 is a perspective view showing the patch antenna according to the second example embodiment.

In FIG. 8, in order to illustrate configuration of the patch antenna 20 according to the second example embodiment in further detail, the dielectric and the liquid crystal are separated. In FIG. 8, the control unit 15, the negative electrode 16, and the positive electrode 17 are omitted for convenience. FIG. 8 shows the meandering transmission line 12m as a signal transmission line.

As shown in FIG. 8, in the patch antenna 20 according to the second example embodiment, the number of the meandering transmission line 12m may be at least one. Alternatively, the number of the spiral transmission line 12s may be at least one.

Note that, four patch antenna elements 14 and four meandering transmission lines 12m corresponding thereto are shown in the example shown in FIG. 8; however, the present invention is not limited thereto. The patch antenna 20 according to the second example embodiment may include the patch antenna element 14 the number of which is not four and the meandering transmission line 12m the number of which is not four.

In addition, the transmission line according to the second example embodiment may be a planar transmission line other than the microstrip line 12, the meandering transmission line 12m, and the spiral transmission line 12s.

### Third Example Embodiment

<Configuration of Antenna>

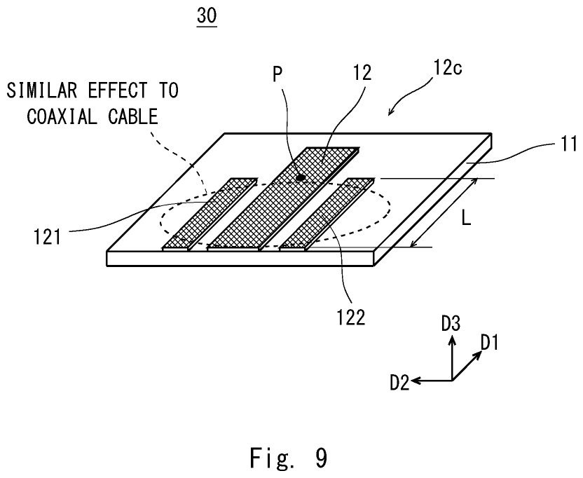

FIG. 9 is a perspective view showing an example of a transmission line of the patch antenna according to a third example embodiment.

In FIG. 9, the dielectric 13 and the patch antenna element 14 are omitted for convenience.

As illustrated in FIG. 9, a patch antenna 30 according to the third example embodiment is different from the patch antenna 10 according to the first example embodiment in further including a first grounding line 121 and a second grounding line 122. A line including the microstrip line 12, the first grounding line 121, and the second grounding line 122 is referred to as a coplanar line 12c.

The first grounding line 121 is provided on the liquid crystal 11 in a second direction D2 intersecting the first direction D1 of the microstrip line 12, and extending in the first direction D1. In other words, the first grounding line 121 is provided substantially in parallel to the microstrip line 12. A length of the first grounding line 121 in the first direction D1 is smaller than a length of the microstrip line 12 in the first direction D1. The first grounding line 121 and the negative electrode 16 are electrically connected.

The second grounding line 122 is provided on the liquid crystal 11 in a direction opposite to the second direction D2 of the microstrip line 12, and extending in the first direction D1. In other words, the second grounding line 122 is provided substantially in parallel to the microstrip line 12. A length of the second grounding line 122 in the first direction D1 is smaller than the length of the microstrip line 12 in the first direction D1. The second grounding line 122 and the negative electrode 16 are electrically connected.

A difference between the length of the first grounding line 121 in the first direction D1 and the length of the second grounding line 122 in the first direction D1 is no greater than a predetermined length. In other words, the length of the first grounding line 121 and the length of the second grounding line 122 are substantially the same.

The coplanar line 12c can provide an effect similar to the coaxial cable due to the microstrip line 12, the first grounding line 121, and the second grounding line 122, in which a feed point P shown in FIG. 9 serves as a virtual feed point. The position of the virtual feed point P in the coplanar line 12c can be changed according to the lengths of the first grounding line 121, and the second grounding line 122. By changing the position of the feed point P, a frequency at which the impedance is matched can be changed. Therefore, by using the coplanar line 12c, the matching of the impedance can be further facilitated.

Note that the microstrip line 12 is considered to correspond to an inner conductor of the coaxial cable, and the first grounding line 121 and the second grounding line 122 are considered to correspond to an outer conductor of the coaxial cable.

<Operation of Antenna>

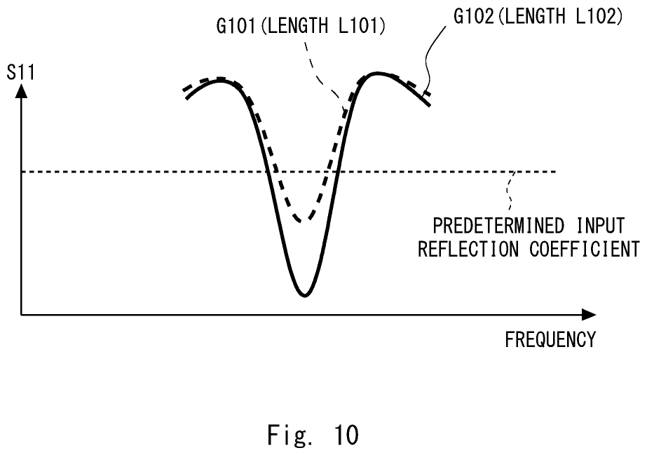

FIG. 10 is a graph showing an example of an operation of the patch antenna according to the third example embodiment.

In FIG. 10, the abscissa represents frequency and the ordinate represents the input reflection coefficient S11.

FIG. 10 illustrate a frequency characteristic of the input reflection coefficient S11 of when the length L of the first grounding line 121 and the second grounding line 122 (see FIG. 9) is changed.

As shown in FIG. 10, when the length L of the first grounding line 121 and the second grounding line 122 is changed from an arbitrary length L101 to an optimal length L102, the graph G101 is moved to the graph G102. As a result, the input reflection coefficient S11 is further reduced, and a frequency range providing a predetermined input reflection coefficient or less is broadened.

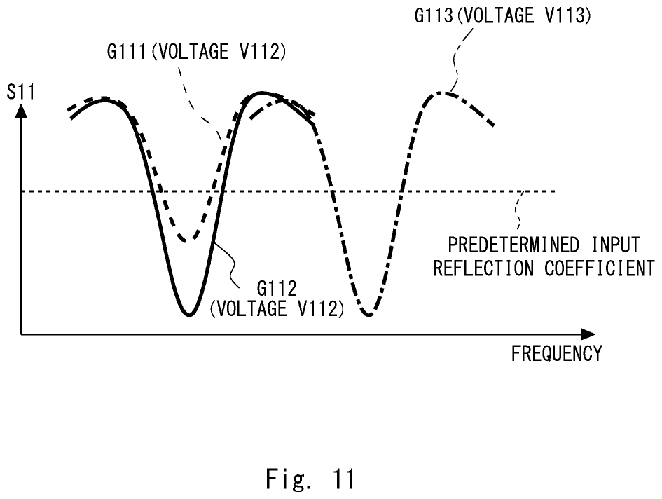

FIG. 11 is a graph showing an example of an operation of the patch antenna according to the third example embodiment.

In FIG. 11, the abscissa represents frequency and the ordinate represents an input reflection coefficient S11.
FIG. 11 illustrate a frequency characteristic of the input reflection coefficient S11 of when the voltage applied to the liquid crystal 11 is changed.

As shown in FIG. 11, when the length L of the first grounding line 121 and the second grounding line 122 is changed from an arbitrary length L101 to an optimal length L102, the graph G111 is moved to the graph G112. As a result, the input reflection coefficient S11 is further reduced, and a frequency range providing a predetermined reflection coefficient or less is broadened. The foregoing description is similar to the content illustrated in FIG. 10. However, the voltage applied to the liquid crystal 11 is a voltage V112.

In this state, when the voltage applied to the liquid crystal 11 is changed from the voltage V112 to a voltage V113, the graph G112 is moved to the graph G113. As described above, also in the patch antenna 30 including the coplanar line 12c, the input impedance can be easily matched at a predetermined frequency.

Note that although the present invention is described as a hardware configuration in the above-described example embodiments, the present invention is not limited to the hardware configurations. In the present invention, the processes in each of the components can also be implemented by having a CPU (Central Processing Unit) execute a computer program.

In the above-described example embodiments, the program may be stored by using various types of non-transitory computer-readable media and supplied to a computer. Non-transitory computer-readable media include various types of tangible storage media. Examples of the non-transitory computer-readable medium include: a magnetic recording medium (specifically, a flexible disk, a magnetic tape, or a hard disk drive); a magneto-optical recording medium (specifically, a magneto-optical disk); a CD-ROM (Read Only Memory); a CD-R; a CD-R/W; and semiconductor memory (specifically, mask ROM, PROM (Programmable ROM), EPROM (Erasable PROM), flash ROM, or RAM (Random Access Memory)). Further, the program may be supplied to a computer by various types of transitory computer readable media). Examples of the transitory computer readable media include an electrical signal, an optical signal, and electromagnetic waves. Transitory computer readable media can provide the program to a computer via a wired communication line (e.g., electric wires, and optical fibers) or a wireless communication line.

Furthermore, although the operation has been described in a specific order, it shall not be construed that such an operation is required to be carried out in a specific order or a consecutive order, or all the presented operations are required to be carried out, for achieving a desired result. In particular circumstances, multitasking and parallel processing may be advantageous. Similarly, although some specific details of the example embodiments are included in the foregoing discussion, these shall be construed not as limitation of a scope of the present disclosure, but as a description particular to a specific example embodiment. Specific characteristics described in relation to different example embodiments may be embodied in combination in a single example embodiment. To the contrary, various characteristics described in relation to a single example embodiment may be embodied separately, or in an arbitrary appropriate combination, in a plurality of example embodiments.

Note that the present invention is not limited to the above-described example embodiments, and can be modified appropriately without departing from the scope thereof.

The presently claimed invention has been described with reference to the example embodiments; however, the presently claimed invention is not limited thereto. Various modifications comprehensible by one of ordinary skill in the art within the scope of the presently claimed invention can be made to the configurations and details of the presently claimed invention.

The present application claims the priority of Japanese Patent Application No. 2021-057098 filed on Mar. 30, 2021, the entire disclosure of which is incorporated herein by reference.

### REFERENCE SIGNS LIST

10, 20, 30, 50 PATCH ANTENNA
11 LIQUID CRYSTAL
12 MICROSTRIP LINE
12m MEANDERING TRANSMISSION LINE
12s SPIRAL TRANSMISSION LINE
12c COPLANAR LINE
121 FIRST GROUNDING LINE
122 SECOND GROUNDING LINE
13 DIELECTRIC
14 PATCH ANTENNA ELEMENT
15 CONTROL UNIT
16 NEGATIVE ELECTRODE
17 POSITIVE ELECTRODE
51 DIELECTRIC
D1 FIRST DIRECTION
D2 SECOND DIRECTION
25 D3 THIRD DIRECTION
BW, BW1, BW2 FREQUENCY RANGE
G31, G32, G33, G41, G42, G101, G102, G111, G112, G113 GRAPH
V31, V32, V33, V41, V42, V112, V113 VOLTAGE
S11 INPUT REFLECTION COEFFICIENT
P VIRTUAL FEED POINT
L, L101, L102 LENGTH

What is claimed is:

1. A patch antenna comprising:
a microstrip line on which a signal is transmitted, provided on liquid crystal and extending in a first direction;
a dielectric provided on the microstrip line;
a patch antenna element provided on the dielectric, that obtains the signal from the microstrip line through electromagnetic bonding and transmits the signal; and
at least one memory storing instructions, and
at least one processor configured to execute the instructions to;
change permittivity of the liquid crystal based on a voltage applied to the liquid crystal to match an input impedance of the patch antenna at a predetermined frequency.

2. The patch antenna according to claim 1, wherein the at least one processor configured to execute the instructions to determine that the input impedance is matched when the input impedance of the patch antenna is within the predetermined impedance range at the predetermined frequency.

3. The patch antenna according to claim 1, further comprising:
a negative electrode provided in contact with a lower face of the liquid crystal; and
a positive electrode provided to be connected to the microstrip line,
wherein
the at least one processor configured to execute the instructions to use the positive electrode and the negative electrode to apply the voltage to the liquid crystal.

4. The patch antenna according to claim 1, wherein a meandering transmission line or a spiral transmission line is used instead of the microstrip line.

5. The patch antenna according to claim 4, wherein the number of the meandering transmission line is at least one, and
the number of the spiral transmission line is at least one.

6. The patch antenna according to claim 1, further comprising:
a first grounding line provided on the liquid crystal in a second direction intersecting the first direction of the microstrip line, and extending in the first direction; and
a second grounding line provided on the liquid crystal in a direction opposite to the second direction of the microstrip line, and extending in the first direction,
wherein
a length of the first grounding line in the first direction is smaller than a length of the microstrip line in the first direction, and
a length of the second grounding line in the first direction is smaller than a length of the microstrip line in the first direction.

7. The patch antenna according to claim 6, wherein a difference between the length of the first grounding line in the first direction and the length of the second grounding line in the first direction is no greater than a predetermined length.

8. A method for controlling input impedance of a patch antenna comprising:
a microstrip line on which a signal is transmitted, provided on liquid crystal and extending in a first direction; a dielectric provided on the microstrip line; and a patch antenna element that obtains the signal from the microstrip line through electromagnetic bonding and transmits the signal, the method comprising:
changing permittivity of the liquid crystal based on a voltage applied to the liquid crystal; and
matching input impedance of the patch antenna at a predetermined frequency by changing permittivity of the liquid crystal.

9. A program for controlling input impedance of a patch antenna including: a microstrip line on which a signal is transmitted, provided on liquid crystal and extending in a first direction; a dielectric provided on the microstrip line; and a patch antenna element that obtains the signal from the microstrip line through electromagnetic bonding and transmits the signal, the program causing a computer to carry out:
changing permittivity of the liquid crystal based on a voltage applied to the liquid crystal; and
matching input impedance of the patch antenna at a predetermined frequency by changing permittivity of the liquid crystal.

10. The method according to claim 8, further comprising:
determining that the input impedance is matched when the input impedance of the patch antenna is within the predetermined impedance range at the predetermined frequency.

11. The method according to claim 8, further comprising:
using a positive electrode and a negative electrode to apply the voltage to the liquid crystal, wherein
the negative electrode provided in contact with a lower face of the liquid crystal; and
the positive electrode provided to be connected to the microstrip line.

12. The method according to claim 8, further comprising:
using a meandering transmission line or a spiral transmission line instead of the microstrip line.

13. The method according to claim 8, wherein
the number of the meandering transmission line is at least one, and
the number of the spiral transmission line is at least one.

14. The method according to claim 8, wherein
a length of a first grounding line in the first direction is smaller than a length of the microstrip line in the first direction, and
a length of a second grounding line in the first direction is smaller than a length of the microstrip line in the first direction, wherein
the first grounding line is provided on the liquid crystal in a second direction intersecting the first direction of the microstrip line, and extends in the first direction; and
the second grounding line is provided on the liquid crystal in a direction opposite to the second direction of the microstrip line, and extends in the first direction.

15. The method according to claim 8, wherein a difference between the length of the first grounding line in the first direction and the length of the second grounding line in the first direction is no greater than a predetermined length.

16. The program according to claim 9, further comprising:
determining that the input impedance is matched when the input impedance of the patch antenna is within the predetermined impedance range at the predetermined frequency.

17. The program according to claim 9, further comprising:
using a positive electrode and a negative electrode to apply the voltage to the liquid crystal, wherein
the negative electrode provided in contact with a lower face of the liquid crystal; and
the positive electrode provided to be connected to the microstrip line.

18. The program according to claim 9, further comprising:
using a meandering transmission line or a spiral transmission line instead of the microstrip line.

19. The program according to claim 9, wherein
the number of the meandering transmission line is at least one, and
the number of the spiral transmission line is at least one.

20. The program according to claim 9, wherein
a length of a first grounding line in the first direction is smaller than a length of the microstrip line in the first direction, and
a length of a second grounding line in the first direction is smaller than a length of the microstrip line in the first direction, wherein
the first grounding line is provided on the liquid crystal in a second direction intersecting the first direction of the microstrip line, and extends in the first direction; and
the second grounding line is provided on the liquid crystal in a direction opposite to the second direction of the microstrip line, and extends in the first direction.
